(19) United States
(12) Patent Application Publication
(10) Pub. No.: US 2003/0197735 A1
(43) Pub. Date: Oct. 23, 2003

(54) System for sharing content tabs

(75) Inventor: Hugh A. Woltzen, Portland, OR (US)

Correspondence Address: MARGER JOHNSON & McCOLLOM, P.C., 1030 S.W. Morrison Street, Portland, OR, 97205, US

(73) Assignee: Intel Corporation (a Delaware Corporation), Santa Clara, CA

(21) Appl. No.: 10/126,319

(22) Filed: Apr. 18, 2002

(51) Int. Cl. G09G 5/00

(52) U.S. Cl. 345/777

(57) ABSTRACT

A system for sharing content tabs is disclosed. Content tabs contain user defined and arranged information content, typically displayed on a browser page or some other electronic information window. The disclosed system includes procedures where one user can share their content tabs with other users. In one embodiment the content tab is packaged and sent to an email address of the recipient user, who can choose whether to accept the tab. In other embodiments, the recipient users can view tabs available for downloading and download them directly. Once accepted, the content tabs are associated with the new user and become part of an information window of the new user.

### TECHNICAL FIELD

This disclosure relates to sharing information among computer users, and, more particularly, to sharing content tabs among users of a computer system.

### BACKGROUND

Present computer systems can provide voluminous amounts of information to users. The relative ease of serving information over the World Wide Web or using a web-type interface as a window into an information database fuels the development of electronic information dissemination systems. The amount of information that system users demand continues to grow, however. Therefore, a continuing need exists for optimizing the organization of the voluminous information so that it can best benefit the users.

A common way to present information to users is to have the users operate a browser window that shows a series of formatted pages of information. An improvement to forcing a user to proceed through a series of pages is the use of a tab metaphor, which is a navigational aid that provides a conceptual categorization of information. In this improvement, a series of tabs are placed in a display window as an interface to multiple documents. Selecting one of the tabs causes an associated page to appear in the display window. Just as in the physical world where writing on paper tabs of folders indicates the contents of papers kept within the particular folders, computer generated tabs are used to indicate the contents of a page displayed when the tab is selected.

FIG. 1 shows an example of an information window 10 that includes a series of tabs 15. There are four tabs 15 shown in the window 10 of FIG. 1, but almost any number of tabs could be present. Each tab 15 includes a tab label portion 16 and an associated tab page portion 18. One of the tabs 15 in the window 10 is selected at any given time. For instance, in FIG. 1, the tab labeled “Client” is selected. Selecting any of the tab labels 16 by, for instance, clicking it with a mouse, causes the window 10 to display the tab's associated tab page 18, and the previously displayed tab page 18 is then covered by the new page. Typically, all of the tab labels 16 for the tabs 15 on the window are always viewable on the window 10, which allows for their easy selection.

In some information systems, users are allowed to design content or customize different tab pages. For instance, some commercial news websites allow a user to individualize a page such that the user's local news and weather appear when the user connects to the news site. Once reason for allowing so much customization is that each user may have different preferences about what should be displayed on their pages so that they derive the most benefit possible from the page.

Oftentimes, however, customizing page views is difficult and time consuming, which can leave a user frustrated. Frustrated users who do not customize their views may stop visiting the site, thereby depriving them of the information they could otherwise receive.

Embodiments of the invention address these and other deficiencies in the prior art.

### BRIEF DESCRIPTION OF THE DRAWINGS

The description may be best understood by reading the disclosure with reference to the drawings, wherein:

FIG. 1 is a view of an information screen that includes tabs.

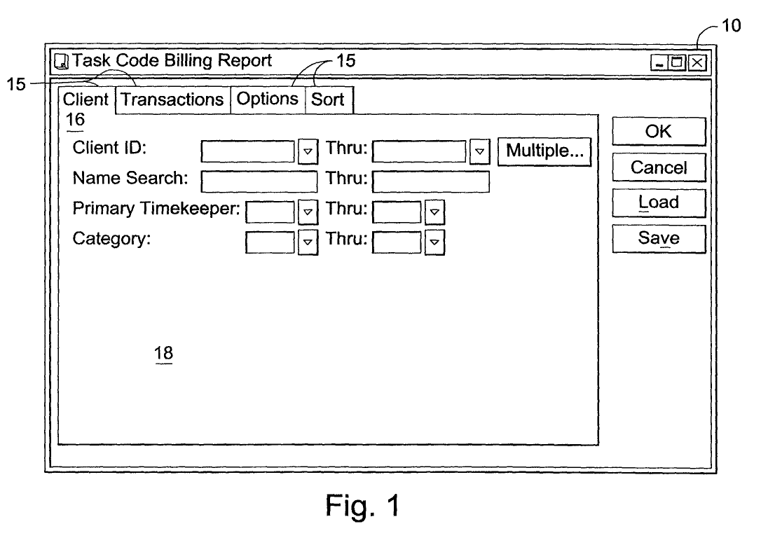

FIG. 2 is a functional block diagram of an information system that can be used to implement embodiments of the invention.

FIG. 3 is a view diagram including a tab sharing function according to embodiments of the invention.

FIG. 4 is a functional block diagram of an information system that can be used to implement embodiments of the invention.

FIG. 5 is an example view of a screen that can be displayed to a content tab owner to share a content tab with another user.

FIG. 6 is an example view of a document that can be presented to a user when a content tab is sent to the user.

FIG. 7 is an example flow diagram showing processes that can be used in embodiments of the invention.

FIG. 8 is an example flow diagram showing processes that can be used in other embodiments of the invention.

FIG. 9 is an example flow diagram showing processes that can be used in still other embodiments of the invention.

### DETAILED DESCRIPTION

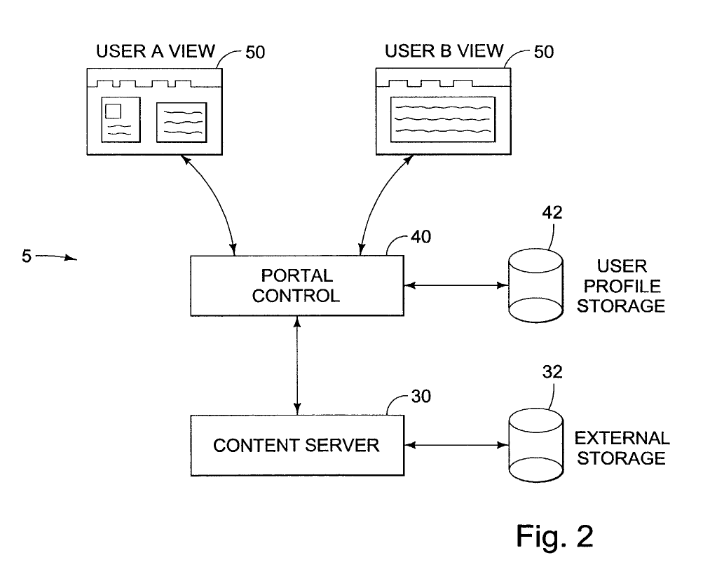

FIG. 2 is a functional block diagram of an information system 5. A content server 30 stores information content that can be ultimately delivered to a user of the information system 5. Some or all of the information content stored by the content server 30 may be stored in a storage repository 32, which may or may not be separate from the content server 30 itself. The content server 30 can, of course, store any type of information for use by the users, such as text, data, static or moving images, audio data, templates, forms, etc.

The content server 30 is coupled to a portal control 40, which can format the content stored on the content server for use by users of the information system 5. The portal control 40 includes various functions useful in the operation of the system 5 such as, for example, an HTTP (Hypertext Transport Protocol) or “web” server that delivers HTML (Hypertext Markup Language) pages to users in response to user input, a JAVA application server (J2EE) that implements java code and scripts initiated by a user's machine, etc. The portal control 40 can be implemented by computer programs running on a computer system, for instance. Additionally coupled to the portal control 40 is a user profile storage facility 42, which stores user preferences, pages, templates, forms, and other information, including the tabs 15 that each user has selected to appear on a personal user page.

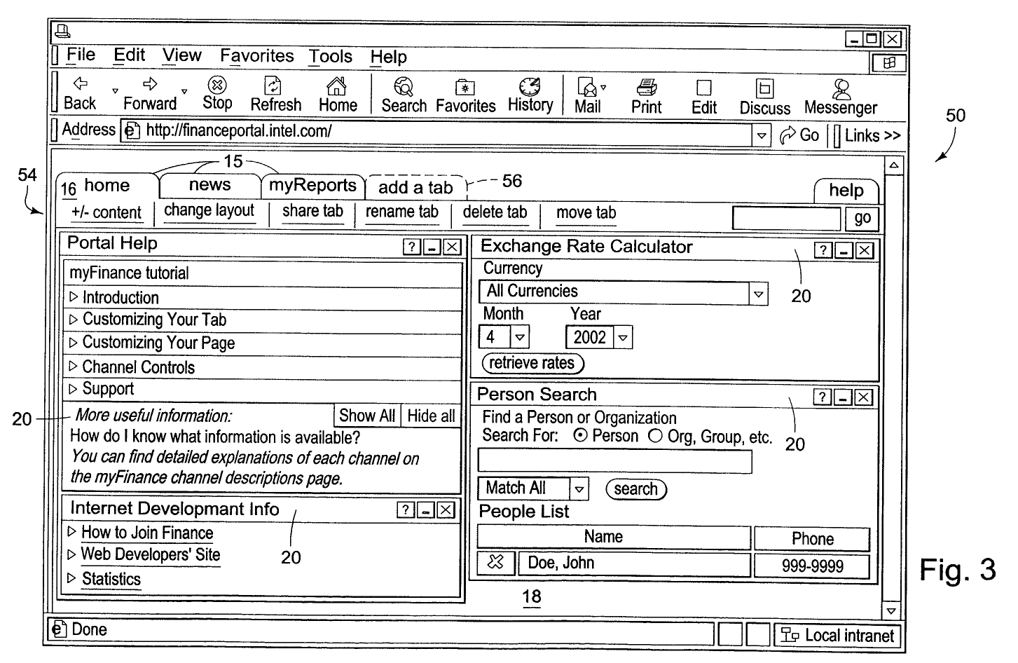

Users A and B each have views 50 displayed on their machines (not shown) that are automatically brought up when the user connects to the portal control 40 and the content server 30 using a document viewer or browser. The browser could be running on a typical computer or workstation, e.g. The views 50 are similar to a “home page” on a typical World Wide Web system. An example view 50 is illustrated in FIG. 3. In the view 50 are a set of tabs 15 that have been customized for a particular user. A user can customize his or her view 50 in several ways, one of which is to design which tabs 15 will be present in the view, and what content that the page, portions 18 of the tabs will contain.

A set of tab management tools 54 are located on the view 50 of FIG. 3. Shown are tools that allow the user to add or delete content from the page portion 18 of a current tab 15, change the layout of the page portion of the current tab, share the tab with another user, rename the tab label 16 portion, delete the tab entirely, and move the tab. Also an add-a-tab function tool 56 is presented as one of the tab labels 16 itself, to indicate that the added tab label will be located in its place. Of course other tools 54 could be present on the view 50, or some views 50 may not include all of the tools listed above.

Some of the tools 54 are self-explanatory. For instance, adding deleting and renaming the tabs 15 allow the user to add, delete, and rename the tabs within their view 50. The move tab tool 54 allows the user to move any of their already created tabs 15 to any position within a maximum of five tabs allowed within the view 50 of the information system 5. For instance, the “myReports” tab 15 on the view 50 of FIG. 3 could be moved to the first tab position on the left, occupying the space where the “home” tab is currently situated. Of course, the limit on a maximum number of tabs 15 is up to the system designer, and not necessarily limited to five.

The change layout tool and the add/delete content tools allow the user to determine the way information shown on their tabs 15 is presented, and which information is included. For instance, the page portion 18 of the selected tab 15 (“home” in the view 50 of FIG. 3) includes four sub-windows 20 in a particular layout. The add/delete content tool allows the user to select which sub-windows 20 will be on each page portion 18 of each tab 15. In a financial environment, such as the one the view 50 of FIG. 3 is in, common sub-windows 20 that may be placed on a home tab 15 include: “Portal Help”, “Internet Development Info”, “Exchange Rate Calculator” and “Person Search”. On a news tab 15 might be found: competitor information, marketing information, and finance specific news. A directory tab 15 may include User lookups and lists of popular financial sites. One tab 15 may be named my reports, and various reports are viewed or printed from there. A tool tab 15 may include exchange rates calculator or a user lookup. A discussion tab 15 may include a link to various discussion forums, where users can read and post topics on discussion groups. Of course, the types of content available to be selected and have its layout customized by the users will vary depending on the underlying information system 5. Embodiments of the invention are not limited to such specifics as described above, but can be applied to any conforming information system.

When a user is added to the information system 5, they are assigned a default view 50, which may or may not include pre-formatted tabs 15. Each user is then allowed to design their own information tabs 15 by using the add tab tool 56 and the content and layout tools. Tabs 15 can be thought of as templates, where each template has a particular associated layout and particular content selected to fill that layout. The template in turn points to data stored on the content server 30. In some embodiments, the template can be formatted by objects, as is known in the art.

Embodiments of the invention allow a user to use another of the tab tools 54, “share a tab”, to transfer a particular tab to a second user so that the second user can also use the first user's tab in the second user's view 50. Sharing tabs allows information created for a first user to be used by the second user, without requiring the second user to re-create the information that the first user already created.

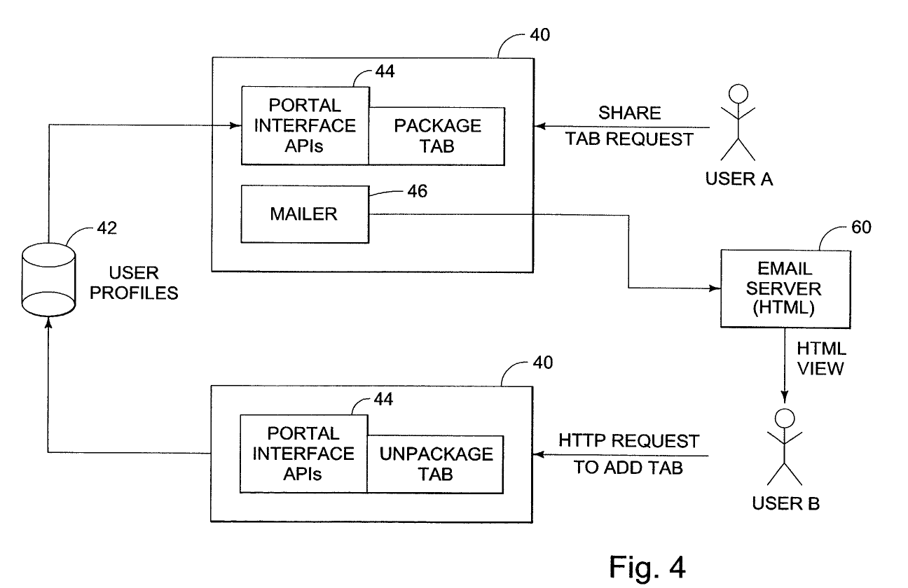

One system that can be used to transfer a tab 15 from one user to another is illustrated in FIG. 4. In that figure, the portal control 40 includes interface applications or APIs 44 that interface between the portal control, the user profile storage 42, and users of the information system 5. The share a tab tool 54 is initiated by a user A selecting the share tab tool on user A's view 50 such as that shown in FIG. 3. The particular tab 15 that will be shared is the current tab selected on user A's view 50. Selecting the share tab tool 54 signals a “package tab” or some similar function of the portal interface APIs 44 to copy the structure of the selected tab 15. Copying the structure of the tab 15 can be performed by copying the template for the tab 15, or by extracting objects and/or data from objects that make up or describe the template and placing them into an XML (Extensible Markup Language) string, for example. Such objects or data within the objects includes content of the tab 15, the layout format of the tab, and the name of the tab. Of course, not all templates for the tabs 15 need include all of the data listed above, and other templates could include additional or different information.

A mailer process 46 can also be present within the portal control 40, as is shown in FIG. 4. The mailer 46 can be JAVA based so that it can be easily integrated with the portal interface APIs 44, for instance. Once the portal interface APIs 44 have packaged the selected tab 15 to be mailed in XML, the mailer 46 creates an HTML document containing the XML codes that were copied from the tab 15 and sends the HTML document to an email server 60, specifically addressed to a user B, who is receiving the HTML document having the tab codes inside.

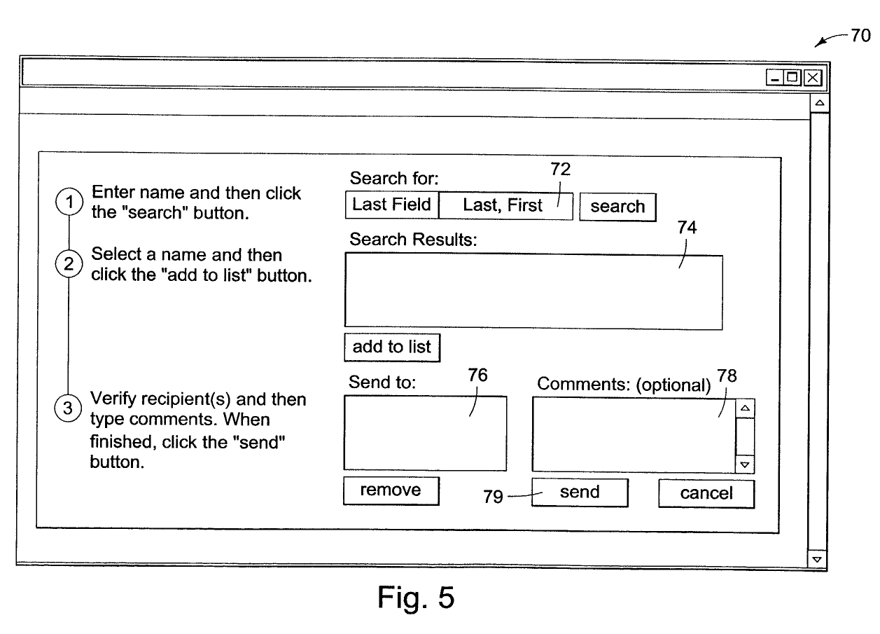

FIG. 5 shows an example screen 70 that appears for user A after user A selects the send a tab tool 54 from FIG. 3. The screen 70 is used to initiate a request that the tab 15 be sent to the user B. On screen 70, an input box 72 allows the tab owner (user A) to search for a correct email address of an intended recipient of the tab to be sent. Search results are presented in a textbox 74. Or, the user A may already know the intended recipient's address and simply enter the known email address in an input box 76. Comments can be added in a text input box 78, which will be presented to the user as described below. To cause the tab 15 to be copied and the email containing the tab to be sent to the desired user as described above, the user A selects a “send” button 79.

Returning back to FIG. 4, the packaged tab 15 sits in the HTML formatted email on the email server 60 waiting to be “read” by user B. User B reads the email by connecting to the email server 60 and downloading an email message containing the codes of the tab 15. By viewing the email containing the HTML codes, user B can decide if he or she wants to download the tab 15 into their own view 50 or if he or she wants to delete the email and not incorporate the tab.

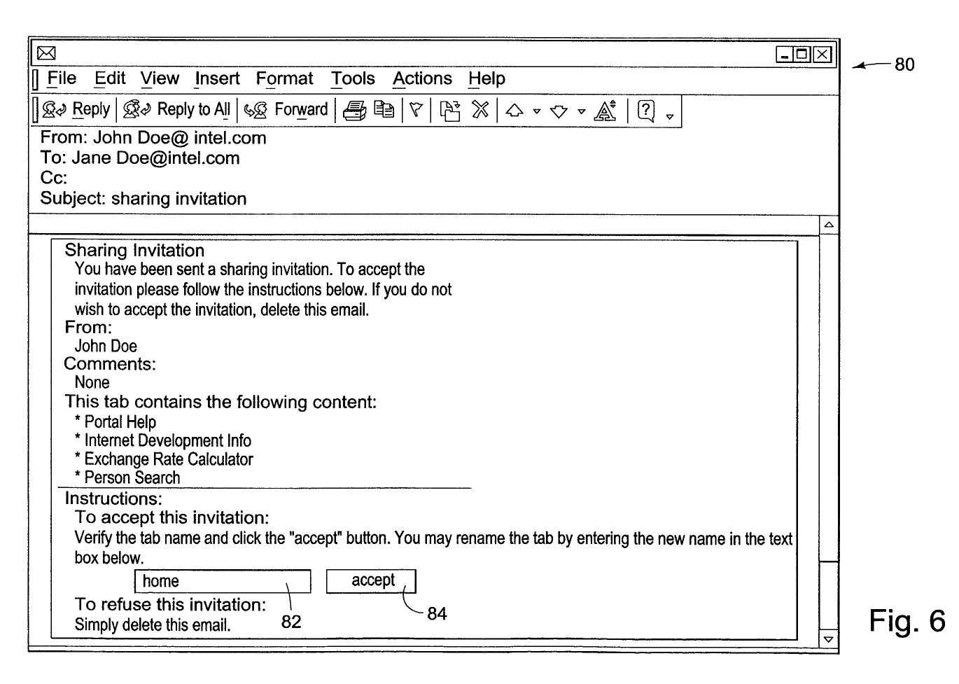

FIG. 6 shows an example HTML formatted email message 80 that can be downloaded by user B from the email server 60. The email 80 gives information about the share-a-tab process, and instructs the user B how to accept the tab 15 from user A. Additionally, any comments entered from user A in the text box 78 of FIG. 5 are shown. Although the coded tab 15 information is contained within the email 80, much of the tab information itself is not displayed. User B can change the name of the tab 15 in a text box 82, which is originally filled by the name that user A had called the tab. User B selects an “accept” button 84 to download the tab 15 into their personal view 50.

If user B chooses to incorporate the tab 15 into their own view 50, then he or she clicks on the accept button 82. That action causes a browser window to open on User B's machine and sends an HTTP request to an unpackage or similar function in the portal interface APIs 44 of the portal control 40 (FIG. 4). After the tab 15 is unpacked, the portal interface API 44 validates the tab, and, if the tab is validated, stores the tab in the storage facility 42 as one of user B's tabs.

The portal interface API 44 performs several validations on the tab 15 prior to storing it as one of user B's tabs in the view 50. For instance, the tab label 16 of the newly transferred tab 15 must be different than all of the other tab labels 16 of the tabs 15 already in user B's view. Additionally, because in the information system 5 there is a maximum of five tabs 15 available for each user, if the user already has five tabs, then the new tab cannot be validated. Finally, if user B enters a new tab name in the text box 82 of the tab email 80, then the name must have no illegal characters and have a length equal to or shorter than a maximum. Other validations could be performed, of course

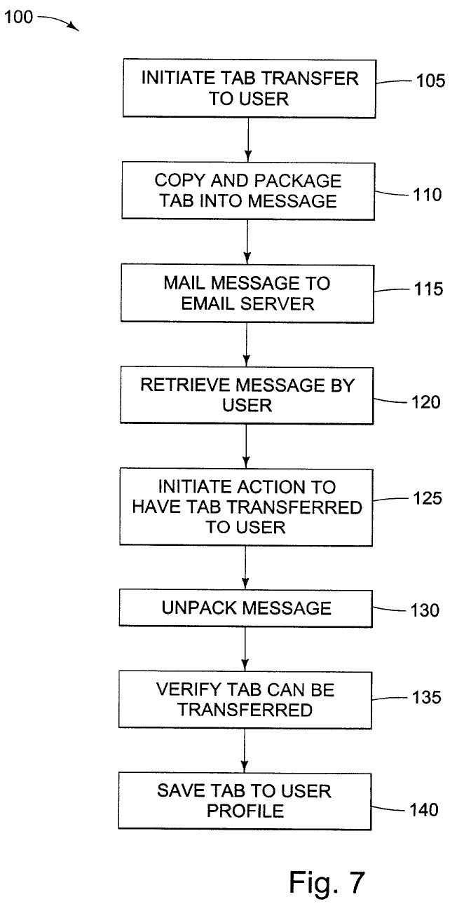

FIG. 7 lists example processes of embodiments of the invention used to effectuate a transfer of tab 15 to a user of an information system. A flow 100 begins at a process 105 where a tab transfer is initiated to be sent to a user. The user, to receive the tab, may initiate the process himself or herself, or a first user may select a particular tab to be transferred to another user.

After the particular tab 15 is determined that it will be sent to the user, data from the tab 15 is copied and perhaps packaged or extrapolated in a process 110. One embodiment for carrying out this process would be, for instance, pulling out the necessary information objects and packing them using XML. Additionally this XML coding making up the structure of the tab could then be placed within an HTML document. Once the document is created in the process 110, a process 115 sends it over to an email server 60 (FIG. 4). This can be performed in a number of ways. For instance, as described above, a JAVA process can be executed on the portal control 40 that generates the email and sends it to the email server 60. Other mechanisms could also be used. After the process 115 sends the packaged tab email to the email server 60, it can also generate a message to user A showing that the transfer was successful.

In a process 120, user B connects to the email server 60 and retrieves the message (such as the formatted HTML message 80 of FIG. 6) that includes the coded tab 15. An HTML displayer, typically found in email programs, is used to view the email message 80. Then, once the receiving user B has decided that he or she will accept the tab 15, they click on the accept button 84, which is one implementation of a process 125 of FIG. 5 to have the tab inserted as one of user B's.

In process 130, the tab 15 is unpacked and its contents are examined. Recall that in some examples a tab 15 includes content, layout and a name, and that, in information system 5, each of the users has to individually subscribe to specific content for it to appear in their view 50. Therefore, the process 130 automatically subscribes the user to the content that is in the newly transferred tab 15. The process additionally unpacks the layout of the original tab as well.

In a process 135, all of the tab verification processes discussed above are performed to ensure that user B can accept the tab. One such verification is that user B does not already have a tab 15 with the same name as the new tab. In some systems, not all users are able to subscribe to all types of content. For instance, managers may be able to generate lists of subordinates, while the subordinates have no such ability to generate lists of peers. In those cases, or others where specific content is governed by privileges or rights afforded the user, the process 135 will additionally check to ensure that the user B has the correct privileges to accept the tab 15.

Finally, in process 140, the new tab 15 is added to user B's user profile in the storage facility 42 of the information system 5. A message can then be generated for user B to be displayed in the browser window on user B's machine that the tab sharing operation was successful, or, if there were errors, the message could inform what errors occurred. When user B subsequently connects to the content server 30 and the portal control 40, the new tab will appear in user B's view 50.

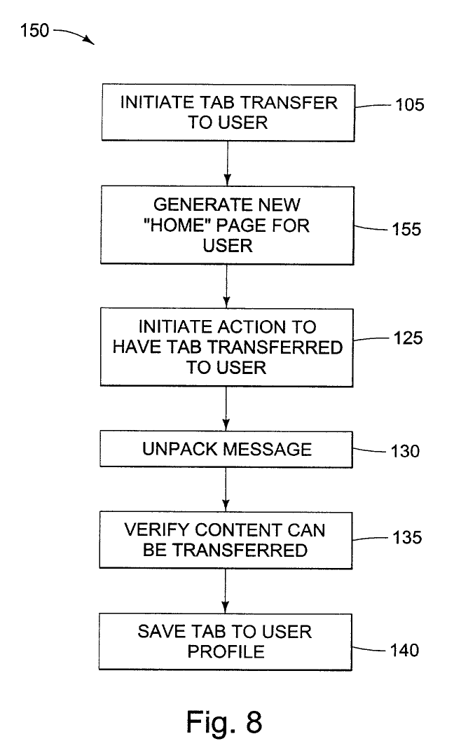

FIG. 8 is an example flow diagram used to explain another method that can be used to transfer a tab 15 from one user to another in an information system. Many of the processes in FIG. 8 overlap those of FIG. 7, and, for brevity, the overlapping processes will not be discussed with reference to FIG. 8.

In FIG. 8, a flow 150 also includes the process 105 repeated from FIG. 7, except that to implement that process, the user A, who originally has the tab 15 in his or her view 50, initiates a transfer to user B, who doesn't have the tab. User A may click on the share-a-tab tool 54 on his or her view 50, for instance. A process 155, implemented by one of the portal interface APIs 44, then generates a new “home” page for the user B, so that the next time the user B connects to the content server 30 and the portal control 40, the user B sees an opportunity to download a new tab. The new “home” page for user B could be the same or a similar format of the email 80 shown in FIG. 6.

Clicking on the accept button 84 or another similar process performs the action of process 125 to initiate the tab sharing, similar to that in FIG. 7. The remaining processes 125-140 of the flow 150 of FIG. 8 are the same as in the flow 100 of FIG. 7, and the new tab 15 is delivered to the user B in the same manner. To implement the flow 150 of FIG. 8, there is no need for the email server 60 in the portion of the information system 5 illustrated in FIG. 4, so that could be eliminated.

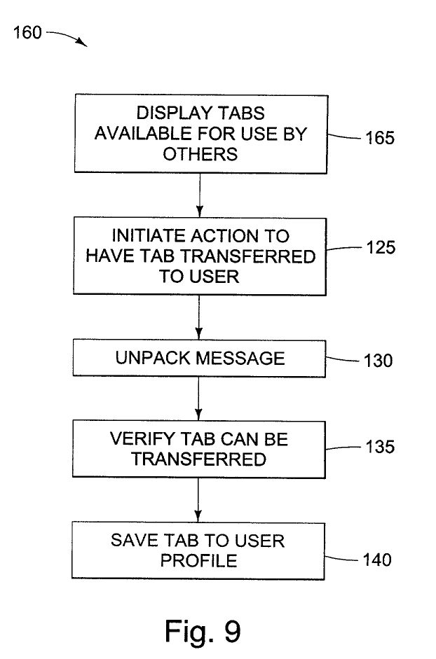

FIG. 9 illustrates yet another example flow 160 used for sharing a tab 15 with a user of the information system 5. In that flow, a process 165 is performed of presenting a list of possible tabs 15 to download into user's personal views 50, such as by displaying a “download tab” web page viewable by all users of the information system 5. The download page may be updated by other users as they create tabs they wish to make available to share. In this scenario, clicking on the share-a-tab tool 54 in their views 50 causes the currently selected tab 15 to be added to the “download tab” page. Or, managers of the information system 5 could generate their own tabs, and place them on the “download tab” page for users to add to their views 50. Process 125 could then be implemented performed by users simply selecting a button from the “download tab” page to indicate a particular tab 15 is to be added to the view 50, and the remaining processes 130-140 would add the tab to the user's view, as was performed in flow 100 of FIG. 7.

Having a system by which users can easily acquire content tabs that others have created can greatly reduce the amount of time, energy and resources spent in creating the tabs themselves. Having such a process to easily customize content tabs increases the chances that users of such information systems will derive useful benefit from the systems, and will find the systems easy and intuitive to use.

Although “tabs” are the vehicle for sharing content in an information system above described, nothing limits embodiments of the invention from appearing differently than they do in the above figures. For instance, the same “tabs” as described herein can appear in other forms, such as a “drop-down” list, select list or other menu type systems.

Implementation of the tab sharing system is straightforward and intuitive once the details of the invention as described above are known. As always, implementation of the invention is left to the system designer. The methods, procedures and functions used to describe embodiments of the invention do not form the invention itself, but are rather used to implement the invention. The methods, procedures, and functions presented herein are not necessary inherently associated with any particular computer or other apparatus. Rather, various general-purpose machines may be used with computer programs in accordance with the teachings herein, or it may prove more convenient to construct more specialized apparatus.

Thus, although particular embodiments for a tab sharing system in an information system have been discussed, it is not intended that such specific references be considered as limitations upon the scope of this invention, but rather the scope is determined by the following claims and their equivalents.

What is claimed is:

1. A method for sharing a content tab, comprising:
initiating an action indicating a particular content tab is to be transferred to a user;
copying a structure of the particular content tab;
transferring the copied tab structure to the user; and
associating the transferred tab structure with the user.

2. The method of claim 1, further comprising verifying that the user can accept the transferred tab structure.

3. The method of claim 1 wherein initiating an action indicating a particular content tab is to be transferred to a user comprises an owner of the particular content tab selecting the particular content tab to be transferred to the user.

4. The method of claim 1 wherein initiating an action indicating a particular content tab is to be transferred to a user comprises the user selecting the particular content tab to be transferred to the user.

5. The method of claim 4 wherein the particular content tab is one of a plurality of content tabs available to be selected by the user.

6. The method of claim 5 wherein the plurality of content tabs is presented to the user in the form of a list of content tabs.

7. The method of claim 1 wherein copying a structure of the particular content tab comprises copying a layout structure and a content list of the particular content tab.

8. The method of claim 1 wherein copying a structure of the particular content tab comprises extracting data from the particular content tab and formatting the extracted data.

9. The method of claim 1 wherein transferring the copied tab structure to the user comprises sending the structure of the particular content tab to an address associated with the user.

10. The method of claim 9 wherein sending the structure of the tab to an address comprises executing a java application on a computing device.

11. The method of claim 1 wherein associating the transferred tab structure with the user comprises storing the transferred tab structure in a user profile.

12. A method for sharing an information content tab having a layout scheme and a particular content such that when the information content tab is selected in a viewing window, an information page containing the particular content arranged according to the layout scheme is displayed in the viewing window, the method comprising:
selecting a particular information content tab to be shared;
selecting a user with whom the particular information content tab is to be shared;
copying the particular content and the layout scheme of the particular information content tab;
delivering the copied content and the layout scheme to the user; and
when the user indicates acceptance of the delivered copy, creating a copy of the particular information content tab and storing it in a user profile of the user.

13. The method of claim 12, further comprising, prior to creating a copy of the particular information content tab, verifying that the user can accept the copy of the particular information content tab.

14. The method of claim 12 wherein selecting a user with whom the particular information content tab is to be shared comprises an initiator of the sharing of the particular content tab:
selecting a tab transfer tool from a page indicating the particular information content tab; and
entering an address of the user on a page subsequently displayed to the initiator.

15. The method of claim 12 wherein copying the particular content and the layout scheme of the particular information content tab comprises:
retrieving a template of the particular information content tab from a user profile storage device;
extracting from the template objects of information that specify the layout scheme and the particular content of the particular information content tab; and
coding the objects of information.

16. The method of claim 15 wherein coding the objects of information comprises storing formatting using XML codes.

17. The method of claim 15, further comprising creating an HTML document including the coded objects of information.

18. The method of claim 17 wherein delivering the copied content and the layout scheme to the user comprises sending the HTML document to an email server.

19. The method of claim 18 wherein sending the HTML document comprises running a java application on a computing device.

20. A system for content tab sharing in an information system, comprising:
a first user profile stored on a storage device, the first user profile associated with a first user and including one or more tab templates for a content tab used by the first user;
a profile interface structured to, upon receiving a copy signal, copy portions of a selected tab template;
a tab coder structured to code the copied portions of the selected tab template into a format other than an original format of the tab template;
a tab deliverer structured to send the coded template to an address of a second user;
a tab decoder structured to, when signaled by the second user, decode the sent coded template into a copy of the selected tab template; and
a second profile interface structured to add the copy of the selected tab template to a user profile of the second user.

21. The system of claim 20 wherein the tab deliverer is a mailer structured to send the coded template to an email address of the second user.

22. The system of claim 21 wherein the mailer is a java application executing on a computer device.

23. The system of claim 20 wherein the tab coder is structured to code the copied portions of the selected tab into an XML string.

24. The system of claim 23 wherein the tab mailer is structured to, prior to sending the coded template, create an HTML document.

25. The system of claim 20, further comprising a tab validator structured to validate that the second user can accept the copy of the selected tab template prior to the time the copy of the selected tab template is added to the user profile of the second user.

26. The system of claim 20 wherein each of the one or more tab templates includes a structure framework of a respective content tab, the structure framework including a list of content included in the content tab.

27. The system of claim 26 wherein the information system requires users to be subscribed to content included in each content tab, and wherein the second profile interface is further structured to subscribe the second user to the list of content contained in the copy of the selected tab template.

28. The system of claim 27, wherein the structure framework also includes a layout format of the respective content tab.
